(19) United States
(12) Patent Application Publication
(10) Pub. No.: US 2006/0032249 A1
(43) Pub. Date: Feb. 16, 2006

(54) Refrigerator

(75) Inventor: In-bo Shim, Daijeon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD., Suwon-si (KR)

(21) Appl. No.: 11/152,154

(22) Filed: Jun. 15, 2005

(30) Foreign Application Priority Data
Aug. 13, 2004 (KR) 2004-63955

(51) Int. Cl. F16P 1/00; F25C 1/00; E03B 7/10

(52) U.S. Cl. 62/135; 62/340

(57) ABSTRACT

A refrigerator having a main body cabinet including a cooling compartment, a door opening and closing the main body cabinet, and an ice making device provided within the cooling compartment which makes ice from water supplied from a water supply source with cool air, including: a water supply valve between the water supply source and the ice making device; a water hose connecting the ice making device and the water supply valve and supplying the water to the ice making device; and a water amount controlling device between the water supply hose and the water supply valve, uniformly maintaining the amount of water supplied to the ice making device from the water supply source.

### CROSS-REFERENCE TO RELATED APPLICATION

This application claims the benefit of Korean Patent Application No. 2004-0063955, filed on Aug. 13, 2004, in the Korean Intellectual Property Office, the disclosure of which is incorporated herein by reference.

### BACKGROUND OF THE INVENTION

1. Field of the Invention

The present invention relates to a refrigerator, and more particularly, to a refrigerator in which the amount of water supplied to an ice making device can be uniformly maintained.

2. Description of Related Art

Keeping pace with a recent rise in the standard of living, large-sized refrigerators having multiple functions, especially a home bar and/or a dispenser, have been launched in the market. Among them are refrigerators having a dispenser enabling users to extract ice (ice cubes) made in a freezing compartment or external water through the dispenser without opening a freezing compartment door.

A refrigerator disclosed in Korean Unexamined Utility Model Publication No. 1999-0020582 includes a main body formed with a freezing compartment and a refrigerating compartment between which a partition is positioned, a freezing compartment door and a refrigerating compartment door rotatably opening and closing respective front openings of the freezing compartment and the refrigerating compartment, and a component chamber in the rear space of the main body, on which a compressor and a condenser are installed. Inside the freezing compartment is installed an automatic ice maker automatically making ice (ice cubes) with water supplied from the outside and dispensing them to a dispenser. In addition, a water supply valve opening and closing a water path from the outside to the automatic ice maker is provided in the component chamber. The water supply valve is branched into two directions: one is connected to the dispenser to thereby supply the water to the dispenser and the other is connected to the automatic ice maker, to thereby supply the water to the automatic ice maker, thereby allowing ice (ice cubes) to be produced with cool air.

Generally an opening time of the water supply valve connected to the automatic ice maker is preset to a microcomputer and thus the water supply valve is controlled so as to supply water to the automatic ice maker during the opening time thereof. However, where the opening time is preset to supply water to the automatic ice maker, this may cause a problem that the proper amount of water is not supplied to the automatic ice maker in a low water pressure area and thus the size of ice (ice cubes) made is small.

To solve this kind of problem, a flow rate sensor has been mounted on the water supply valve. When the water supply valve reaches the proper amount of water, the microcomputer controls the water supply valve to be closed, whereby the proper amount of water can be supplied to the automatic ice maker, regardless of the water pressure. Where the flow rate sensor is mounted, the proper amount of water supplied can be controlled both in low and high water pressures. However, there is a problem that the cost of production increases because of the flow rate sensor.

### BRIEF SUMMARY

Accordingly, it is an aspect of the present invention to provide a refrigerator in which water can be supplied to an ice making device regardless of a change in water pressure and which reduces the cost of production.

According to an aspect of the present invention, there is provided a refrigerator having a main body cabinet including a cooling compartment, a door opening and closing the main body cabinet, and an ice making device provided within the cooling compartment which makes ice from water supplied from a water supply source with cool air, including: a water supply valve between the water supply source and the ice making device; a water hose connecting the ice making device and the water supply valve and supplying the water to the ice making device; and a water amount controlling device between the water supply hose and the water supply valve, uniformly maintaining the amount of water supplied to the ice making device from the water supply source.

The water amount controlling device may include: a water collecting body having an inlet into which the water from the water supply valve flows, an outlet through which the water is discharged out to the water supply hose and a water collecting part collecting the water flown from the inlet; and a piston part selectively passing or blocking the water from the inlet by moving reciprocally within the water collecting body according to opening and closing of the water supply valve.

The piston part may include: a first piston on which a water path is formed, moving within the water collecting body according to the opening and closing of the water supply valve; and a second piston selectively opening or blocking the water path in association with the first piston according to the opening and closing of the water supply valve.

The refrigerator may also include a water path blocking part provided between the first piston and the second piston and blocking the water path when the water supply valve is opened.

The first piston may include a supporting part supporting the second piston and formed with a water passing part through which the water from the inlet passes.

The water blocking part may include a projection formed on the second piston, and a projection accommodating part formed on the first piston and accommodating the projection.

The first piston may include an upper plate and a lower plate each formed with an opening, and a side plate connecting the upper plate with the lower plate, accommodating the second piston inside thereof.

The projection accommodating part may be on the bottom of the upper plate of the first piston and a supporting part is provided on the top of the lower plate.

According to another aspect of the present invention, there is provided a refrigerator including: an ice maker; a supply valve; and a water amount controlling device disposed between the supply valve and the ice maker, including a piston part which moves within the water amount controlling device to compensate for changes in a pressure of water supplied to the water amount controlling device so as to uniformly maintain an amount of water supplied to the ice maker.

According to another aspect of the present invention, there is provided a water amount controlling device including: a water collecting body having an inlet, and outlet, and a water collection part therebetween; and a piston part including a first piston reciprocally moving within the water collecting body and a second piston moving within the first piston, the first piston defining a path around the second piston, the second piston selectively opening and closing the path. When water flows through the inlet, the second piston engages the first piston to block the path and to push the first piston from a rest position toward the outlet so as to discharge through the outlet water in the water collection part between the first piston and the outlet. When water stops flowing through the inlet and the first piston is not in the rest position, the second piston disengages the first piston to open the path so as to allow water to flow through the path, water flows into the water collection part between the first piston and the outlet, and the first piston returns to the rest position.

According to another aspect of the present invention, there is provided a water amount controlling method, including: directing water flowing through an inlet of a water collecting body against a second piston contained in a first piston to press the second piston against a first part of the first piston so as to close a water path defined by the first piston and to push the first piston from a rest position toward an outlet of the water collecting body so as to discharge through the outlet water in the water collecting body between the first piston and the outlet; and allowing, when water stops flowing into the inlet and the first piston is not in the rest position, the second piston to press against a second part of the first piston to open the path so as to allow water to flow through the path.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a schematic diagram illustrating a refrigerator according to an embodiment of the present invention;

FIG. 2 is a perspective view illustrating the rear of the refrigerator of FIG. 1;

FIG. 3A is a sectional view illustrating an initial state of a water amount controlling device when a water supply valve is closed in the refrigerator of FIG. 1;

FIGS. 3B and 3C are sectional views illustrating the water amount controlling device when the water supply valve is opened in the refrigerator of FIG. 1; and

FIG. 3D is a sectional view illustrating the water amount controlling device when the water supply valve is closed as in FIG. 3C.

### DETAILED DESCRIPTION OF EMBODIMENT

Reference will now be made in detail to an embodiment of the present invention, examples of which are illustrated in the accompanying drawings, wherein like reference numerals refer to the like elements throughout. The embodiment is described below in order to explain the present invention by referring to the figures.

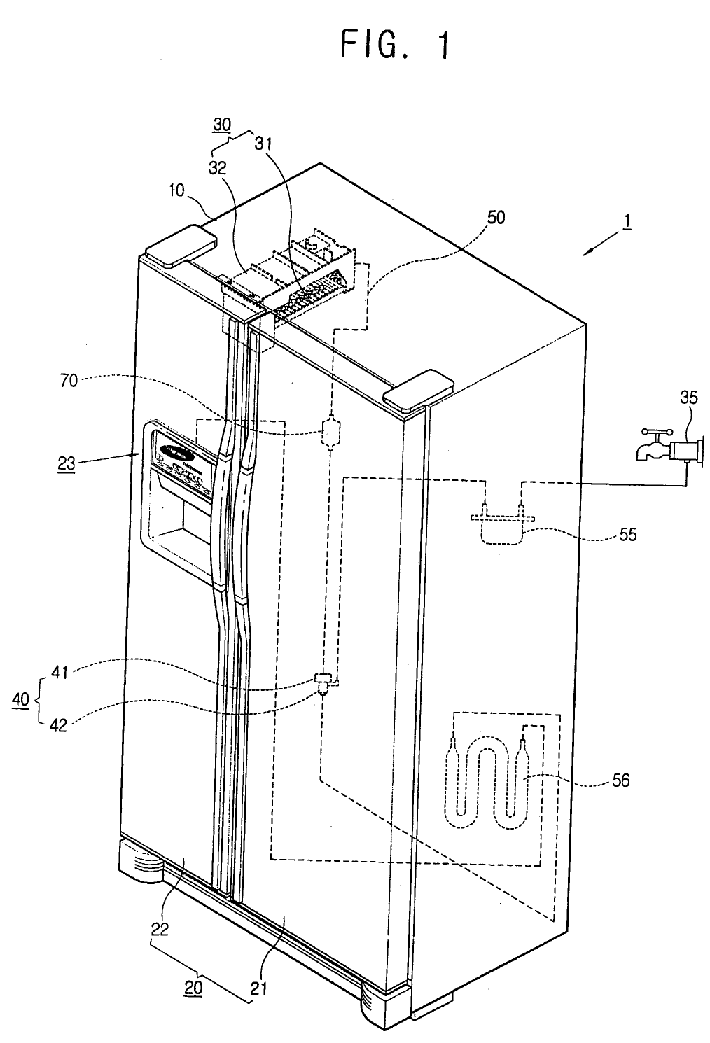

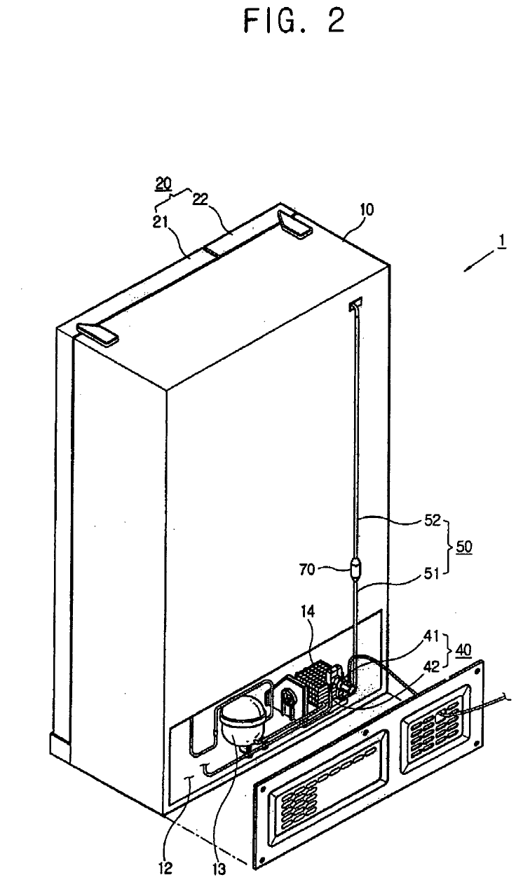

As illustrated in FIGS. 1 and 2, a refrigerator 1 according to an embodiment of the present invention includes a main body cabinet 10 formed with a cooling compartment (not shown), a door 20 opening and closing the main body cabinet 10, an ice making device 30 provided in the cooling compartment which produces ice (ice cubes) with cool air from water supplied from a water supply source 35, a water supply valve provided between the water supply source 35 and the ice making device 30 and which opens and closes a water path, a water supply hose 50 connecting the ice making device 30 with the water supply valve 40 and which supplies the water to the ice making device 30, a water amount controlling device 70 provided between the water supply hose 50 and the water supply valve 40 and which uniformly maintains the amount of water supplied to the ice making device 30 from the water supply source 35.

The cooling compartment includes a refrigerating compartment (not shown) and a freezing compartment (not shown) respectively at the left and the right sides of a partition (not shown). The door 20 is includes of a refrigerating compartment door 21 and a freezing compartment door 22 opening and closing the respective front openings of the refrigerating compartment and the freezing compartment.

In the lower space of the main body cabinet 10 is provided a component chamber 12 in which a compressor 13, a condenser 14 and so on are installed, the compressor 13 compressing a refrigerant at high temperature and low pressure into the refrigerant at high temperature and high pressure, and the condenser 14 condensing the refrigerant supplied from the compressor 13. In the rear space of the main body cabinet 10 are provided an evaporator (not shown) and a ventilating fan (not shown), the evaporator absorbing ambient heat and generating cool air and the ventilating fan forcibly ventilating the cool air generated from the evaporator into the cooling compartment, thereby supplying the cool air to the cooling compartment.

In the freezing compartment are provided a water supply hose 50 being inserted into a foaming material of the main body cabinet 10 from the outside and an ice making device making the water supplied from the water supply hose 50 into ice (ice cubes) with cool air.

In front of the freezing compartment door 22 is provided a dispenser 23 allowing a user to be supplied with water and/or ice (ice cubes) as desired without opening the freezing compartment door 22.

The ice making device 30 includes an ice making part 31 which is supplied with water from the water supply hose 50 and which produces ice (ice cubes) with cool air and an ice making part supporting part 32 provided in the top of the ice making part 31, supporting the ice making part 31.

The water supply hose 50 includes a first water supply hose 51, one end of which is connected to the water amount controlling device 70 and the other end of which is connected to the water supply valve 40, and a second water supply hose 52, one end of which is connected to a water amount controlling device 70 and the other end of which is connected to the ice making device 30.

The water supply valve 40 is branched into two directions, which includes a first valve 41 opening and closing the water path directed to the ice making device 30 from the water supply source 35 and a second valve 42 opening and closing the water path directed to the dispenser 23 from the water supply source 35. A filter 55 filtering the water from the water supply source 35 is installed between the water supply source 35 and the water supply valve 40.

Between the second valve 42 and the dispenser 23 is provided a water tank to store therein the water to be supplied to the dispenser 23 to a specified amount.

Between the first valve 41 and the ice making device 30 is installed a water amount controlling device 70 with which the water to be supplied to the ice making device 30 can uniformly be maintained regardless of water pressure. The water amount controlling device 70 is provided between the first water supply hose 51 and the second water supply hose 52, perpendicularly to the ground.

Referring to FIGS. 1-3D, the water amount controlling device 70 is provided between the first water supply hose 51 and the second water supply hose 52 (shown in FIG. 2), so as to prevent any difference in the amount of water supplied to the ice making device 30 (shown in FIG. 1) according to the change in water pressure. Especially in the low water pressure area, decrease of ice (ice cubes) in size, produced in the ice making part 31 (shown in FIG. 1), due to insufficient amount of water supplied to the ice making device 30, may be prevented, thereby enhancing the quality of ice (ice cubes). The water amount controlling device 70 may be of a cylindrical shape as shown, including a water collecting body 71 formed with a water collection part 72 collecting therein water and a piston part 75 reciprocally moving within the water collecting body 71.

Since the proper amount of water which the ice making device 30 requires depends upon the size of the water amount controlling device 70, a large-sized water amount controlling device 70 may be installed when the proper amount of water requested by the ice making device 30 is large whereas a small-sized water amount controlling device 70 may be installed when the proper amount of water requested by the ice making device 30 is small. In comparison of the conventional flow rate sensor, the cost of production may be saved by selectively installing the proper size of the water amount controlling device 70 as requested by the ice making device 30.

The water collecting body 71 includes an inlet 71a into which water from the water supply valve 70 flows through the first water supply hose 51 (shown in FIG. 2), a water collecting part 72 collecting the water flown in from the inlet 71a to the specified amount and an outlet 71b through which the water collected in the water collecting part 72 is flown out to the second water supply hose 52. The water collecting body 71 includes a lower engaging part 74 provided between the water collecting part 72 and the inlet 71a, and a upper engaging part 73 provided between the water collecting part 72 and the outlet 71b. In this configuration, when the piston part 75 is engaged with the upper engaging part 73, it is blocked from moving upward within the water collecting body 71. In addition, when the piston part 75 is engaged with the lower engaging part 74, it is blocked from moving downward within the water collecting body 71.

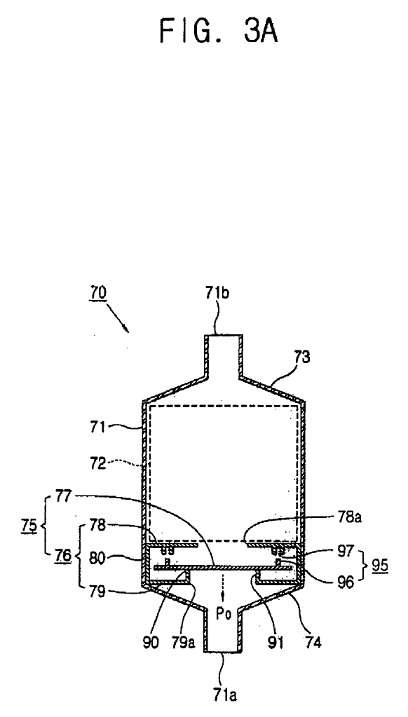

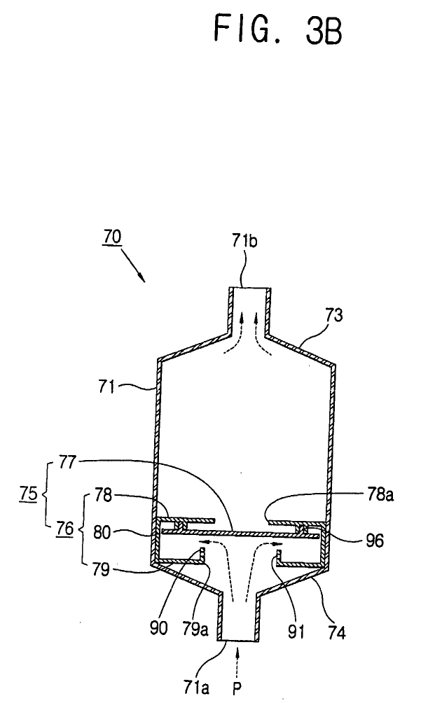

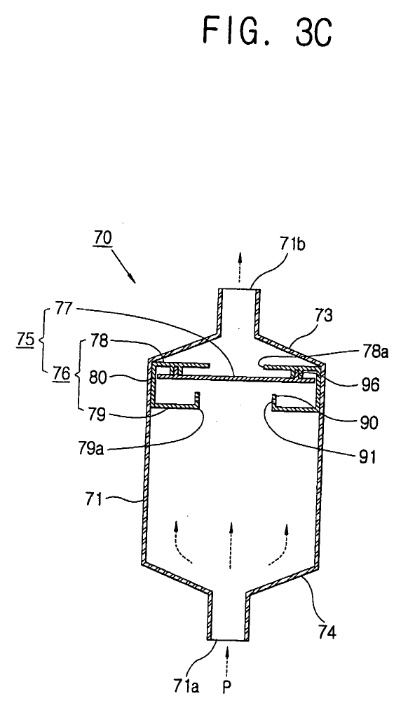

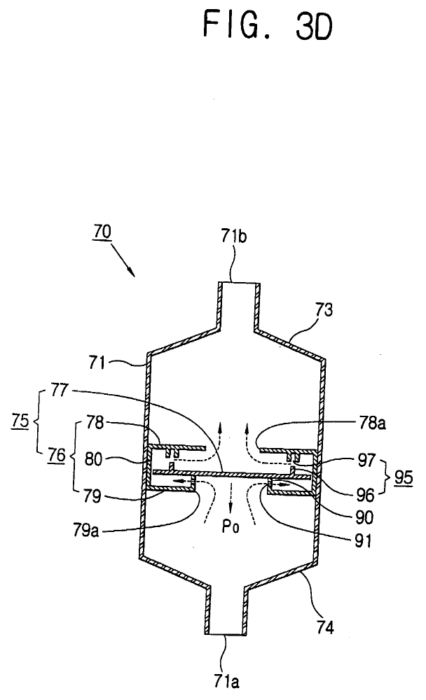

The piston part 75 can move reciprocally (represented by the hash lines in FIG. 3A) within the water collecting body 71 according to opening and closing of the water supply valve 40 (shown in FIG. 2), thereby selectively passing or blocking the water from the inlet 71a. The piston part 75 includes a first piston 76 that moves within the water collecting body 71 according to opening and closing of the water supply valve 40, thereby forming a water path, and a second piston 77 that selectively opens or blocks the water path, in association with the first piston 76. When the first valve 41 is opened, the second piston 77 pushes against the first piston 76 and thus pushes the first piston upward due to the water pressure P to thereby block the water path of the first piston 76 and pushes the water collected in the water collecting part 72 to the specified amount out to the outlet 71b. The piston part 75 continues to move upward relative to the water collecting body 71 because of the water pressure P but it does not go ahead any more since it is engaged with the upper engaging part 73. As water continuously flows into the water collecting part 72 through the inlet 71a as much as the specified amount to be collected in the water collecting part 72. When the first valve 41 is closed, the piston part having been engaged with the upper side of the water collecting body 71 moves downward due to its own weight P0 in association with the second piston 77 and the first piston 76, thereby allowing the water path of the first piston 76 to be opened. Here, the piston part 75 continuously moves downward relative to the water collecting body 71 due to its own weight P0 but it does not go ahead any more since it is engaged with the upper engaging part 74.

The first piston 76 includes a upper plate 78 having an opening part 78a, a lower plate 79 having an opening part 79a and a side plate 80 connecting the upper plate 78 with the lower plate 79. The second piston 77 is accommodated inside the first piston 76. The first piston 76 and the second piston 77 are associated with each other due to the water pressure P or its own weight P0, whereby they can move within the water collecting body 71.

On the top of the lower plate 79 of the first piston 76 is provided a supporting part 90 supporting the second piston, being formed with a water passing part 91 through which the water from the inlet 71a passes.

A water path blocking part 95 is provided between the first piston 76 and the second piston 77, the water path blocking part 95 blocking the water path when the water supply valve 40 is opened.

The water path blocking part 95 includes a projection 96 formed on the second piston and a projection accommodating part 97 formed on the first piston 76, accommodating the projection.

The projection 96 is formed on the top face of the second piston 7. When the first valve 41 is opened, the projection 96 is accommodated in the projection accommodating part 97 as the second piston 77 moves upward due to the water pressure P. Accordingly, the course of water flown into the water collecting part 72 is blocked, thereby allowing the water to be supplied to the ice making device 30 uniformly as much as the amount of water collected in the water collecting part 72.

The projection accommodating part 97 is provided in the bottom face of the upper plate 78 of the first piston, corresponding to the projection 96, being so structured as to be capable of accommodating the projection part 96. The projection 96 and the projection accommodating part 97 have no limitation in shape and may be shaped in a various manner as far as it can block or open the water path according to opening and closing of the first valve 41.

With this configuration, a process to operate the water amount controlling device 70 of the refrigerator 1 according to an embodiment of the present invention will be described with reference to FIGS. 1-3D.

As illustrated in FIG. 3A, when the first valve is closed, a certain amount of water as requested by the ice-making device 30 is collected in the water collecting part 72 of the water collecting body 71 and the piston part 75 is being engaged with the lower engaging part 74 its own weight P0.

Subsequently, when the second valve is opened and water pressure is applied to the second piston as illustrated in FIG. 3b, the second piston 77 moves upward within the water collecting body 71 to thereby push the first piston 76 upward. The projection 96 formed on the second piston 77 is accommodated in the projection accommodating part 97 formed on the first piston 76, thereby blocking the course of water flowing to the water collecting part 72 from the inlet 71a. Accordingly, only the water collected in the water collecting part 72 is discharged out to the outlet 71b, thereby allowing only the amount of water supply as necessary to be supplied to the ice making device 30. In this process, the water flowing into the inlet 71a passes through the water passing part 91 to thereby flow into the water collecting part 72. In addition, the piston part 75 moves upward due to the water pressure P until it engages with the upper engaging part 73 of the water collecting main body 71 whereby it cannot move upward any more, as illustrated in FIG. 3C. The opening time of the first valve 41 in FIGS. 3B and 3C should be determined through due consideration, so that the constant amount of water can be supplied even in the low water pressure area. On the other hand, in the high water pressure area, since the water is collected as much as the size of the water collecting part 72 even though the opening time of the first valve 41 is longer than the requested time, the constant amount of water can be supplied to the ice making device 30.

When the constant amount of water to be supplied to the ice making device is collected in the water collecting device 72, the first valve 41 is closed as illustrated in FIG. 3D, and the second piston 77 engaged with the upper engaging part 73 responsively moves downward within the water collecting body 71 due to its own weight P0 to thereby push the first piston 76 downward. Here, the water path of the first piston 76 blocked by the water path blocking part 95 is opened since the projection 96 and the projection accommodating part 97 are separated from each other, thereby allowing the water collected below the piston part 75 to pass through the water passing part 91 and be collected in the water collecting part. And the piston part 75 moving downward due to its own weight P0 does not go ahead any more because it is engaged with the lower engaging part 74 of the water collecting body 71.

According to the above-described embodiment of the present invention, there is provided a refrigerator in which the amount of water supplied to an ice making device can uniformly be maintained, regardless of a water pressure.

In addition, according to above-described embodiment of the present invention, there is provided a refrigerator whose production cost can be saved in comparison of the conventional flow rate sensor, by selectively installing the water amount controlling device in size according to the amount of water as requested by the ice making device.

Although an few embodiment of the present invention has been shown and described, the present invention is not limited to the described embodiment. Instead, it would be appreciated by those skilled in the art that changes may be made to the embodiment without departing from the principles and spirit of the invention, the scope of which is defined by the claims and their equivalents.

What is claimed is:

1. A refrigerator having a main body cabinet including a cooling compartment, a door opening and closing the main body cabinet, and an ice making device provided within the cooling compartment which makes ice from water supplied from a water supply source with cool air, comprising:
a water supply valve between the water supply source and the ice making device;
a water hose connecting the ice making device and the water supply valve and supplying the water to the ice making device; and
a water amount controlling device between the water supply hose and the water supply valve, uniformly maintaining the amount of water supplied to the ice making device from the water supply source.

2. The refrigerator according to claim 1, wherein the water amount controlling device includes:
a water collecting body having an inlet into which the water from the water supply valve flows, an outlet through which water in the water amount controlling device is discharged to the water supply hose and a water collecting part collecting the water flown from the inlet; and
a piston part selectively passing or blocking the water from the inlet by moving reciprocally within the water collecting body according to an opening and a closing of the water supply valve.

3. The refrigerator according to claim 2, wherein the piston part includes:
a first piston defining a water path and moving within the water collecting body according to the opening and the closing of the water supply valve; and
a second piston selectively opening or blocking the water path in association with the first piston according to the opening and the closing of the water supply valve.

4. The refrigerator according to claim 3, further comprising a water path blocking part between the first piston and the second piston and blocking the water path when the water supply valve is opened.

5. The refrigerator according to claim 3, wherein the first piston includes a supporting part supporting the second piston and formed with a water passing part through which the water from the inlet passes.

6. The refrigerator according to claim 4, wherein the water blocking part includes a projection formed on the second piston, and a projection accommodating part formed on the first piston which accommodates the projection.

7. The refrigerator according to claim 6, wherein the first piston includes an upper plate and a lower plate each formed with an opening, and a side plate connecting the upper plate with the lower plate, and wherein the second piston is accommodated inside the plates.

8. The refrigerator according to claim 7, wherein the projection accommodating part is on a bottom of the upper plate of the first piston and a supporting part is provided on a top of the lower plate.

9. The refrigerator according to claim 1, further comprising a water supply hose provided between the water amount controlling device and the water supply valve.

10. A refrigerator comprising:
an ice maker;
a supply valve; and
a water amount controlling device disposed between the supply valve and the ice maker, including a piston part which moves within the water amount controlling device to compensate for changes in a pressure of water supplied to the water amount controlling device so as to uniformly maintain an amount of water supplied to the ice maker.

11. A water amount controlling device comprising:
a water collecting body having an inlet, and outlet, and a water collection part therebetween; and
a piston part including a first piston reciprocally moving within the water collecting body and a second piston moving within the first piston, the first piston defining a path around the second piston, the second piston selectively opening and closing the path,
wherein, when water flows through the inlet, the second piston engages the first piston to block the path and to push the first piston from a rest position toward the outlet so as to discharge through the outlet water in the water collection part between the first piston and the outlet, and
wherein, when water stops flowing through the inlet and the first piston is not in the rest position, the second piston disengages the first piston to open the path so as to allow water to flow through the path, water flows into the water collection part between the first piston and the outlet, and the first piston returns to the rest position.

12. The water amount controlling device according to claim 11, wherein the first piston includes an upper plate having an opening part and a projection accommodating part around the opening part and extending toward the second piston,
wherein the second piston includes a projection extending toward the upper plate and accommodated by the projection accommodating part when the second piston engages the first piston, and
wherein, when the projection accommodating part accommodates the projection, the projection accommodating part and the projection cooperate to block the path.

13. The water amount collecting device according to claim 11, wherein the piston part moves to the rest position due its own weight.

14. The water amount collecting device according to claim 11, wherein the water collection body is cylindrical.

15. A water amount controlling method, comprising:
directing water flowing through an inlet of a water collecting body against a second piston contained in a first piston to press the second piston against a first part of the first piston so as to close a water path defined by the first piston and to push the first piston from a rest position toward an outlet of the water collecting body so as to discharge through the outlet water in the water collecting body between the first piston and the outlet; and
allowing, when water stops flowing into the inlet and the first piston is not in the rest position, the second piston to press against a second part of the first piston to open the path so as to allow water to flow through the path.

16. The method according to claim 15, wherein the second piston presses against the second part to return the first piston to the rest position.
